(19) United States
(12) Patent Application Publication
(10) Pub. No.: US 2006/0257001 A1
(43) Pub. Date: Nov. 16, 2006

(54) Methods and apparatus for tamper detection in watermarking systems

(76) Inventors: Minne Van Der Veen, Eindhoven (NL); Aweke Negash Lemma, Eindhoven (NL); Alphons Antonius Maria Lambertus Bruekers, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/570,532

(22) PCT Filed: Aug. 26, 2004
(86) PCT No.: PCT/IB04/51575

§ 371 Date: Mar. 3, 2006

(30) Foreign Application Priority Data
Sep. 12, 2003 (EP) 03103374.9

(51) Int. Cl. G06K 9/00

(52) U.S. Cl. 382/100

(57) ABSTRACT

The invention relates to watermarking systems, which irregularly change the embedded watermark so as to avoid hacking the system by averaging-attacks. In averaging attacks, segments of the watermarked signal are accumulated. This causes the host signal to be cancelled out whereas the embedded watermark accumulates coherently. A watermark A thus determined is then subtracted by a hacker from the watermarked signal. This invention exploits the insight that the hacker does not know when the embedded watermark changes (from A to B, or from A to none). Accordingly, fragments of the hacked signal will contain the negative watermark—A being unintentionally embedded by the hacker. This causes the watermark detector to produce a correlation peak of opposite polarity. The invention resides in the detection of such a negative peak, and concluding therefrom that the signal has been tampered. The payload of the watermark is preserved. This provides the possibility to trace back the hacker.

### FIELD OF THE INVENTION

The present invention relates to method and apparatus for detecting tampering in a watermarked information signal, for example, a multimedia signal, such as audio, video or data signals.

### BACKGROUND OF THE INVENTION

Watermarking of information signals is a technique for the transmission of additional data along with the information signal. For instance, watermarking techniques can be used to embed copyright and copy control information into audio signals.

Many watermark applications rely on the assumption that the watermark is secure. In the context of watermarking, security refers to the inability of an unauthorised user to have access to the raw watermarking data. In other words, an unauthorised user (“hacker”) should not be able to remove, detect, estimate, write or modify the raw watermarking data.

One example of such an attack is the so called “averaging-attack”. This attack makes use of the fact that the watermark is embedded with some redundancy, i.e. the watermark is repeated. If this repetition pattern is known or can be estimated (either by trial-and-error, experiment, or by studying related documents), the information signal may be averaged over time.

For instance, if the information signal is an audio signal, the averaging could be done in either the temporal or spectral domain (depending upon the watermark embedding technique utilised). As the audio signal is expected to change over time, whilst the watermark remains constant, the watermark signal will be accumulated coherently. Thus, by averaging a sufficient amount of audio signal, a relatively accurate estimate of the watermark can be made. Subsequently, knowledge of this watermark may be used to modify the information signal to remove or render unrecognisable the watermark signal. For instance, assume that a watermark signal is utilised to provide copy-protection, then if the watermark is modified so as to be unrecognisable by a detector, this will allow the information signal to be copied.

In order to make the watermark more robust to hacking attacks such as averaging, WO 01/99049 describes a method of embedding a watermark in an information signal by embedding different versions of the watermark in successive portions of the signal. The versions are different with respect to a property that is irrelevant for detection of the watermark.

WO 01/39121 describes a method of embedding a watermark in an information signal, the watermark being selected from a set of different watermarks in dependence upon a predetermined property of the signal. For example, the distribution of luminance values of a video image may be determined, and a watermark selected based upon the determined luminance value.

The inventors have also developed a more robust watermarking technique described in European Patent application number 02078615.8 (docket number PHNL020825) hereinafter referred to as [Veen 2002] in which at least two different watermarks are randomly embedded in an information signal. The watermarks are different with respect to a property which is relevant for detection of each watermark and an averaging type attack carried out against such a watermarking system will be unsuccessful as there is no predefined pattern for embedding the two watermarks.

Although such methods enhance the security of the watermark and make averaging attacks more difficult, it is also useful to be able to detect instances in which a watermarked information signal has been attacked. If an attack can be detected, then appropriate action such as denying an end user access to playback rights to the information content of the attacked signal may be desirable.

It is an aim of embodiments of the present invention to provide methods and apparatus for tamper detection in a watermarked information signal.

It is a further aim of embodiments of the invention to provide methods and apparatus in which when tampering has been detected, access to information in a watermarked signal is denied.

It is a still further aim to provide a method and apparatus in which tampering may be traced to a user or group of users.

### SUMMARY OF THE INVENTION

According to a first aspect of the invention, there is provided a method of tamper detection in watermarking systems, the method comprising a comparison operation carried out during detection in which a watermark detected within a received information signal is compared to an expected watermark, the comparison operation being such that a property which is relevant for the positive detection of the expected watermark is compared to the equivalent property of the detected watermark, and if said property is detected as being altered then tampering is deemed to have taken place.

In the above method, a simple comparison between a property of an expected and the equivalent property of the detected watermark to check for alteration in the property is sufficient to yield a decision on whether tampering has occurred or not.

Preferably, in the comparison operation a received watermark is correlated with an expected watermark and if the correlation is sufficiently negative, it is decided that tampering with the information signal has occurred.

A second aspect provides a method for detecting a watermark comprising the steps of:

receiving a potentially watermarked multimedia signal;

estimating the embedded watermark sequence in the said multimedia signal; correlating said estimated watermark with a reference watermark; and

comparing a resulting correlation peak against a threshold level so as to determine if there has been tampering or not

Correlation checks of this kind provide an extremely simple and effective means of comparison and sufficiently highly negative correlation is compelling evidence that an averaging attack has taken place.

A third aspect concerns a method of detecting tampering with a watermark in an information signal, comprising the steps of: receiving an information signal that may potentially be tampered with and which is potentially watermarked with at least one watermark randomly embedded in the original information signal; analysing said signal so as to detect said watermark; comparing the detected watermark with the expected watermark; and

if said detected watermark comprises an approximate negative version of the expected watermark then determining that tampering has occurred.

With randomly embedded watermarks, a hacker is highly likely during averaging attacks to erroneously insert negative versions of the watermark at signal positions not matching the positions of the original watermark and the detection of such negative versions provides a convenient means of assessing whether tampering has occurred.

Preferably, the detected watermark carries a payload which is specific to a user or group of users, and tampering with the watermark is indicative of tampering by the user or group of users. The provision of user specific payloads in this manner enables the forensic tracking of hackers who may then be dealt with in an appropriate fashion.

A fourth aspect of the invention provides an apparatus arranged to detect a watermark in an information signal, the apparatus comprising an estimator for estimating the presence of a watermark in a received multimedia system, and a comparison module for comparing the estimated watermark with an expected watermark and deciding that tampering has taken place if the comparison module shows a sufficiently negative correlation between the estimated and expected watermarks.

In a fifth aspect, there is provided an apparatus arranged to detect tampering with a watermark in an information signal comprising:

receiving means arranged to receive a signal that may potentially be watermarked by at least one watermark randomly embedded in the original information signal;

first analysing means arranged to analyse said signal so as to detect said watermark; and

second analysing means arranged to analyse said watermark so as to detect whether said watermark is a close match to an expected watermark, wherein said second analysing means is arranged to detect both positive correlation and negative correlation peaks between the received and expected watermarks, a sufficiently high positive correlation peak indicating correct receipt of a watermark and a sufficiently high negative correlation peak indicating that the information signal has been tampered with.

Other aspects of the invention will be apparent from the dependent claims.

### BRIEF DESCRIPTION OF THE DRAWINGS

For a better understanding of the invention, and to show how embodiments of the same may be carried into effect, reference will now be made, by way of example only, to the accompanying diagrammatic drawings in which:

FIG. 1 shows schematically the steps for embedding and detecting watermarks in a watermark embedding method compatible with the tamper detecting methods and apparatus of preferred embodiments of the invention;

FIG. 2 shows schematically a diagram of a tamper detection module in accordance with a preferred embodiment;

FIG. 3 shows schematically an example of a hacked signal in relation to an original signal, the hacked signal showing evidence of an averaging attack;

FIG. 4 shows schematically an example of a watermark embedder suitable for use with a tamper detection system according to embodiments of the invention;

FIG. 5 shows schematically an example of a watermark detector in which tamper detection may be implemented; and

FIG. 6 is a flowchart illustrating schematically a decision process involved in deciding whether or not tampering has occurred.

### DESCRIPTION OF PREFERRED EMBODIMENTS

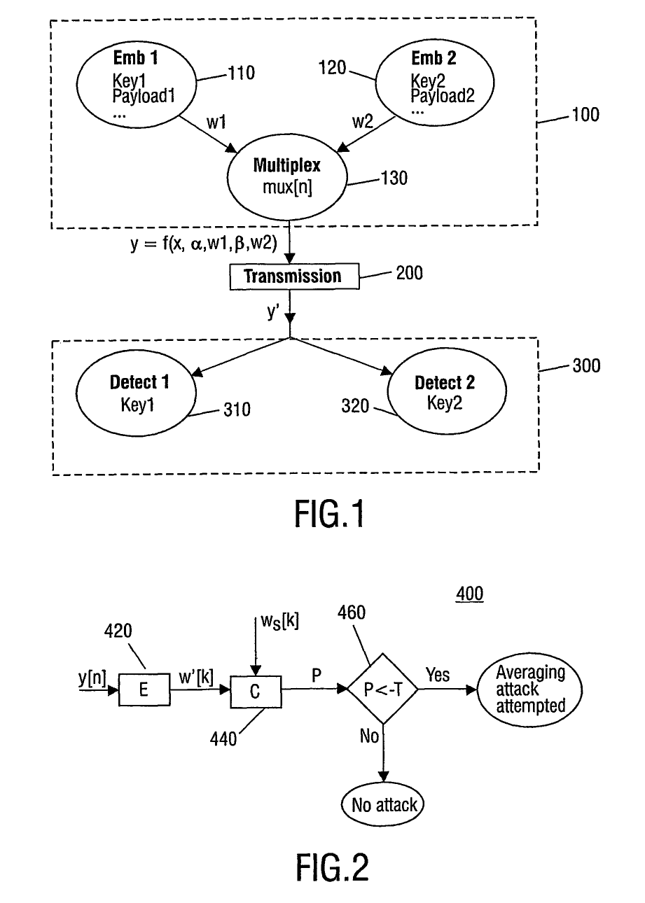

FIG. 1 illustrates the steps involved in embedding a watermark in accordance with [veen 2002]. In [Veen 2002], two separate watermark embedding algorithms (Emb 1, Emb 2), each with associated key (Key 1, Key 2) and payload (Payload 1, Payload 2) are utilised. For instance, examples of such watermark embedding algorithms are described in the articles by M. van der Veen, F. Bruekers, J. Haitsma, T. Kalker, A. W. Lemma and W. Oomen, Robust, multi-functional and high-quality audio watermarking technology, Audio Engineering Society, Presented at the 110th AES convention, 2001. paper no. 5345, and by Lemma et. al, A Temporal domain watermarking Technique Transactions on SP 2003. However, it will be appreciated that other watermark embedding algorithms are equally appropriate.

The embedding algorithms are different, such that the watermark generated by the algorithms will be different with respect to a property relevant for detection of the watermark. This can be achieved by using completely different algorithms (such as the ones mentioned above), or alternately using substantially the same algorithms but changing the parameters that define the watermark, such as the key and/or payload.

A property which is relevant for detection of the watermark is the property of the watermark that must be known in order to successfully detect the watermark. For instance, one should know which watermark system and its respective key (e.g., Emb1/Detect1/Key1) is being used. By using another detection system and/or key (e.g. Emb1/Detect2/Key1) one would, in general, fail to correctly detect the watermark.

Emb 1 is applied to a copy of an information signal to produce a signal with watermark w1 (step 110). Similiarly, Emb 2 is applied to a copy of the same information signal to produce a signal with watermark w2 (step 120).

Both the signal containing w1 and the signal containing w2 are passed to a multiplexing module.

The multiplexing module acts to randomly switch between the two input signals in accordance with a randomly generated multiplexing function mux[n] (step 130).

The function mux[n] determines the way the signals carrying w1 and w2 are multiplexed into a single signal. This is generally done by mixing the two signals with the relative weights of α and β, respectively (i.e. the signals are mixed with different relative strengths; in the simplest case, different amplitudes al). When the weights α, β are random binary digits with α=1−β, the output signal is generated by randomly multiplexing the two signals. The mux[n] function also determines the time duration for which the individual signals are proposed.

The resulting output signal, as determined by the function mux[n] is then applied to the original information signal, resulting in a watermarked signal.

By randomly varying the embedding parameters as described above and in [Veen 2002], the security of the watermark is improved, as it is very difficult for a hacker to average the resulting signal to identify the watermark. Whilst other watermarking techniques have used mapping functions to change the signal properties of the watermark, a hacker having knowledge of the type of mapping function can design a more appropriate attack. As in this instance the mapping function (i.e. the multiplexing function) is randomly generated, it is difficult for a hacker to design a better averaging attack.

The watermark signal y is subsequently output from the embedder (100), for onwards transmission (200), or for storage e.g. in a computer memory or on a recording medium such as a compact disc.

At the detector (300), the signal y is received and/or read. Subsequently, a copy of the signal y is passed to each of the detecting modules, (310, 320). Each detecting module is utilised to detect a respective watermark i.e. the first detecting module can only detect the watermark w1 (310), and the second detecting module (320) can only detect the watermark w2 (320). In this instance, the detection is carried out using a respective key (Key 1, Key 2), as used by the original embedding algorithm to generate the respective watermark w1, w2. At each detecting module, the respective payload (Payload 1, Payload 2) is also extracted (310, 320).

Information on the presence of one or both of the watermarks can be used to convey information such as copy-control conditions. Alternatively, such information can be included in one or more of the payloads of the watermarks.

In principle, any value for the relative weights α, β can be used. A particular preferred embodiment utilises a binary decision, and swaps between α=1, β=0; and α=0, β=1. This effectively results in time-domain multiplexing of the watermark signal, as only one watermark signal is applied to the information signal at any given time.

The above method describes a scenario by which an information signal may be watermarked in a robust manner which is highly resistant to averaging attacks.

Supposing that an averaging attack is made upon the information signal, a method of discovering that such an attack has been made, will now be described in relation to FIG. 2, which shows a tamper detection module which may form part of the detector (300) of FIG. 1.

The tamper detection module is designated generally in-figure 2 as (400) and comprises an estimator E (420), a correlator C (440) and a comparison module (460).

In the tamper detection module of FIG. 2, an incoming watermarked signal y[n](possibly attacked) is passed through watermark estimator E (420)(which here may be, for instance, the first or second detection modules (310) or (320) of FIG. 1). From here, an estimated watermark w′[k] is output and passed to correlator C (440) which produces a correlation peak signal P. The signal P is then compared by the comparison module (460) to a threshold value −T to determine whether an averaging attack has been made upon the signal or not. The signal is deemed to have suffered an averaging attack if P←T.

For a given threshold −T, one can determine that the probability of falsely identifying an averaging attack, assuming that the negative correlation peak is uniformly distributed within the signal y[n] is given by pt=0.5×erfc(T/√2).

To explain the above method further, let us assume that a hacker has managed to estimate an embedded watermark carried in a watermarked signal, such as a copy protected audio signal. Here, in order to remove the copy protection, the hacker will attempt to embed the negative of his estimated watermark throughout the signal at the places in which he believes the original watermark is present. Embedding the negative, if successful, would remove the watermark from the signal so that detection circuitry working on the newly fabricated signal would fail to find any watermark and the copy protection or other features which relied upon such watermarking would be negated.

So, a hacker employing the above type methods will, due to the random nature of the watermarking method used in the arrangements of FIG. 1, inevitably produce a signal y[n] in which a negative watermark embedded by the hacker does not always cancel the true and already existing watermark. Consequently, in several segments, only the negative of the watermark will be present resulting in a highly negative correlation peak being produced by correlator C (440) of FIG. 2 and such a high negative correlation by its' very presence indicates that an averaging attack has been made upon the signal.

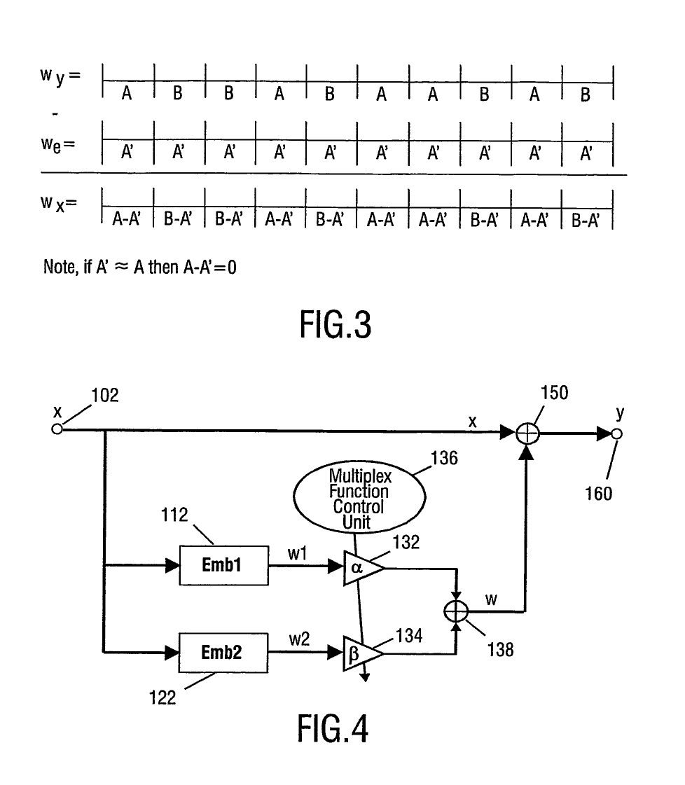

To be more specific, an example is now given in which an original watermarked signal y[n] carries a random time-multiplexed mixture w_{y}[n] of watermarks A and B as shown in FIG. 3. Assume an attacker tries to subtract an estimate A′ of the watermark A (forming the signal wₑ[k]) from the signal w_{y}[n]. The resulting signal wₓ[n] will now contain the watermarks B-A′ and A-A′. If A′ is a good estimate of A, then A-A′0 is approximately zero and B-A′ will be approximately B-A. Assuming that A and B are sufficiently orthogonal, then the detection process for detecting watermark A will be blind to watermark B (as indeed the detection process for watermark B will be blind to watermark A) and in some instances will therefore detect the negative watermark −A′ and produce the highly negative correlation peak referred to.

In the above, we have tacitly assumed that the hacker is possibly able to estimate A, or B, but that the locations at which the watermarked process switches from A to B and vice versa cannot be (or are not) detected with sufficient accuracy. The method still works however if the hacker were able to estimate both A AND B, but was unable to accurately replicate the locations at which the watermarks switch. Such a discussion will also work in cases of [Veen 2002] where B=0 (or indeed A=0), i.e., a system in which there is a randomly embedded single watermark.

Although the above tamper detecting procedures have been discussed in relation to [Veen 2002], it will be appreciated that they may also be applied to other watermarking schemes in which a watermark is randomly embedded, as in all such systems the information gained in one segment of (for example) audio is not exactly the same as that obtained from another segment. Thus, whenever one tries to subtract an estimate of a watermark obtained in one segment from the same or another segment of audio, one introduces new detection behaviours that were not in the originally watermarked content.

Another aspect of the invention relates to forensic tracking in which it is possible to identify a hacker as being a particular user or restricted group of users.

It will be recalled from the discussion of FIG. 1, that each watermark may, as well as bearing a particular key (Key1 or key2), which may form the distinctive characteristics by which a watermark detector detects the watermark, also have an associated payload (payload1, payload2). Such a payload, whilst not forming the mechanism by which the watermark detector detects the watermark, is associated with the watermark and may have a particular function. In such watermarks, it is possible to include a unique identifier as part of the payload and to make that identifier user specific (or specific to a known group of users).

In a system containing a randomised watermark, it has been shown how an averaging attack results in the embedding of an opposite polarity watermark in some portions of the content. This means that, except for the polarity reversal, the watermark payload is preserved and, if a unique payload is associated with a given user, then this individual may be traced as being the hacker.

It will be evident that any number of decisions may be made following the detection of tampering. For instance, playback of the hacked information signal may be disabled.

Whilst the invention has been particularly described in relation to the randomised watermarking system of [Veen 2002], the methods can be extended to detect any unsuccessful averaging attack in any watermarking system whose polarity is invariant to signal inversion.

Whilst the above embodiment has been described in relation to a time-domain signal, it will be appreciated that the principles discussed in relation to tamper detection and tracking can occur in any of the domains utilised in the information signal e.g. within the frequency or spatial domains of a video signal.

FIG. 4 shows an example of an embedder suitable for use in implementing the embedding function illustrated in FIG. 1. The embedder 100 has an input 102 for receiving an information signal x. This is the information signal that is subsequently watermarked.

A copy of the information signal x is subsequently passed to an adder 150, a first embedder 112, and a second embedder 122.

Each of the embedders (112, 122) is arranged so as to apply a respective embedding algorithm (Emb 1, Emb 2) to the information signal x, so as to output respective watermarks w1 and w2 with their respective payloads Payload 1, Payload 2.

Each of the watermarks w1, w2 is applied to a respective gain control unit (132, 134). These gain control units (132, 134) are utilised to control the relative weights α, β of the watermarks w1, w2. The values of α and β at any given time are determined by the multiplex function control unit 136. Both outputs of the gain control unit (132, 134) are provided to an adder 138. The adder outputs the overall watermark signal w, which is a random combination of the two separate original watermark signals w1, w2.

The overall watermark signal w is added to the original information signal x by adder 150, so as to form the watermarked information signal y. The watermarked information signal y is provided to the output (160) of the embedder.

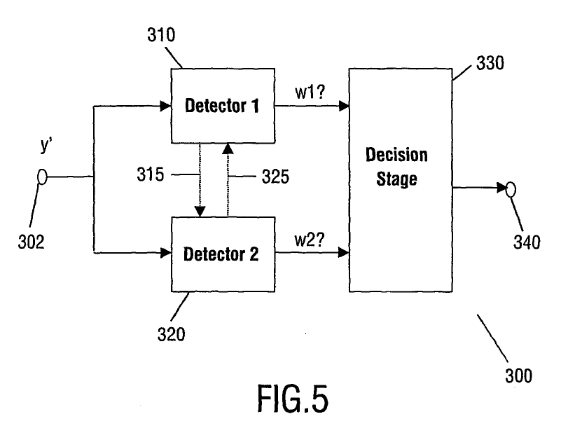

FIG. 5 illustrates a schematic diagram of a detector suitable for use in conjunction with the detection process outlined in FIG. 1 and in conjunction with the tamper detection process explained in relation to FIGS. 2 and 3.

The detector 300 constitutes receiving means for receiving the transmitted watermark information signal y′ at input 302. One copy of the received signal y′ is supplied to first analyzing means comprising a first detector 310 and a second detector 320.

The first and second detectors are each arranged to detect a respective watermark only. I.e., the first detector 310 is specifically arranged to detect whether or not the watermark w1 or its inverse −w1 is within the signal, and the second detector 320 is specifically arranged to detect whether the watermark w2 or its inverse −w2 is within the received information signal y′.

If desired, the detectors (310, 320) may also be utilised to determine any payload incorporated within the respect watermark w1, w2.

Each detector outputs the results to a decision stage 338 constituting second analyzing means. The decision stage (338) includes the correlator function to determine whether the detected watermark has a negative or positive correlation to the expected watermark (w1 or w2). Next, based upon the relevant input e.g. whether both or either of the watermarks are present, and whether in a threshold detecting process a negative correlation peak of a watermark is found to exceed a threshold level, then the appropriate control information to be passed to output 340 is determined. For instance, copy-control information could be determined based upon whether both or either one of the watermarks are present, or upon one or more of the payloads of the watermarks and in the event of detection of an averaging attack, access to signal information may be denied and forensic tracking via the payload information may be instigated.

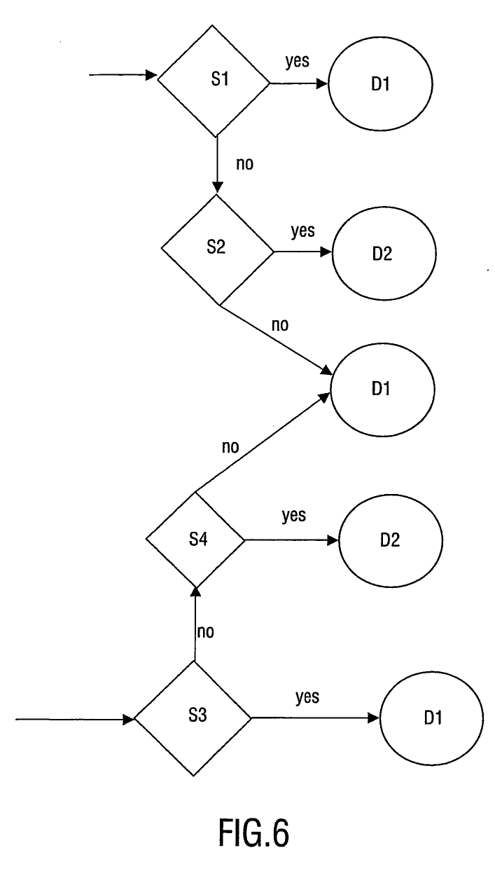

FIG. 6 shows a flow diagram for implementation of the Decision stage 330 of the FIG. 5 arrangement. In the flowchart of FIG. 6, there is shown a plurality of steps S1-S4 and a plurality of decision paths. Steps S1 and S2 relate to deciding whether or not tampering is evident on the basis of tampering with a first watermark W1. Here, in a step S1, it is decided whether there is a positive correlation between a received watermark W1′ and the expected watermark W1. If there is found to be a positive correlation between W1′ and W1, then decision D1 is arrived at, which is that on the basis of the correlation between the received watermark and the expected watermark, there is “no apparent tampering”. On the other hand, if there is a negative correlation between W1′ and W1 then, in step S2, it is checked whether or not the negative correlation exceeds a threshold value T1. If there is a negative correlation, but it is not above the threshold value T1, then no decision can be made as to whether or not there is tampering, so, therefore, decision D1, that there is “no apparent tampering” is once again come to. However, if as a result of step S2, there is found to be a negative correlation which exceeds the threshold value T1, then a decision D2 is reached, namely it is decided that “tampering has been detected” and appropriate action may thereafter be taken.

In similar fashion to the above, received watermark W2′ and an expected watermark W2 are tested for positive correlation in step S3. If there is a positive correlation, then decision D1 is arrived at that there is “no apparent tampering”. If correlation is however found to be negative, then step S4 is undertaken to check the extent of negative correlation. If the negative correlation is less than a threshold value T2, then the decision D1 is taken that there is “no apparent tampering”, whilst if the negative correlation exceeds the threshold value T2, then decision D2 is made, showing “detection of tampering”.

As before, it will be evident that once a decision has been made that tampering is present, further action may be decided to be carried out, such as forensic tracking, blocking of access to information content of the signal etc.

It will be appreciated that the above embodiments are provided by way of example only. For instance, the embodiments have been described utilising only two different watermarks. It will be appreciated that three or more different watermarks could be utilised, with an appropriate random function to control the embedding of all of the watermarks within a host information signal. It will also be appreciated that the tamper detection will also work in situations in which a single watermark is randomly embedded.

Whilst only the functionality of the tamper detecting apparatus has been described, it will be appreciated that either the apparatus could be realised as a digital circuit, an analogue circuit, a computer program, or a combination of thereof.

Within the specification, it will be appreciated that the word “comprising” does not exclude other elements or steps, that “a” or “an” does not exclude a plurality, and that a single processor or other unit may fulfil the functions of several means recited in the claims.

The invention can be summarized as follows. The invention relates to watermarking systems, which irregularly change the embedded watermark so as to avoid hacking the system by averaging-attacks. In averaging-attacks, segments of the watermarked signal are accumulated. This causes the host signal to be cancelled out whereas the embedded watermark accumulates coherently. A watermark A thus determined is then subtracted by a hacker from the watermarked signal.

The invention exploits the insight that the hacker does not know when the embedded watermark changes (from A to B, or from A to none). Accordingly, fragments of the hacked signal will contain the negative watermark −A being unintentionally embedded by the hacker. This causes the watermark detector to produce a correlation peak of opposite polarity. The invention resides in the detection of such a negative peak, and concluding therefrom that the signal has been tampered. The payload of the watermark is preserved. This provides the possibility to trace back the hacker.

1. A method of tamper detection in watermarking systems, the method comprising a comparison operation carried out during detection in which a watermark detected within a received information signal is compared to an expected watermark, the comparison operation being such that a property which is relevant for the positive detection of the expected watermark is compared to the equivalent property of the detected watermark, and if said property is detected as being altered then tampering is deemed to have taken place.

2. The method of claim 1, wherein in the comparison operation a received watermark is correlated with an expected watermark and if the correlation is sufficiently negative, it is decided that tampering with the information signal has occurred.

3. The method of claim 1, wherein if a detected watermark is found to be a negative version of an expected watermark then tampering is deemed to have occurred.

4. The method of claim 1, wherein in the comparison operation a watermark detected within the received information signal is correlated with an expected watermark and if said correlation is a sufficiently negative correlation which exceeds a predetermined negative threshold level, then it is decided that tampering has occurred.

5. A method for detecting a watermark comprising the steps of:
receiving a potentially watermarked multimedia signal;
estimating the embedded watermark sequence in the said multimedia signal;
correlating said estimated watermark with a reference watermark; and
comparing a resulting correlation peak against a threshold level so as to determine if there has been tampering or not.

6. The method of claim 5, wherein it is determined that tampering has occurred if said correlation peak shows a sufficiently negative correlation peak.

7. The method of claim 5, wherein it is determined that tampering has occurred if said correlation peak shows negative correlation below a particular threshold value.

8. A method as in claim 5, wherein sufficiently negative correlation is deemed to be indicative of an averaging attack against the multimedia signal.

9. A method as in claim 5, where the said received multimedia signal carries a watermark whose behaviour changes randomly in time.

10. A method as in claim 5, where the said received multimedia signal carries a plurality of watermarks whose behaviours change randomly in time.

11. A method as claimed in claim 1, wherein in a watermark embedding step, the embedding parameters of the watermarks or the watermarks themselves are randomly varied.

12. A method as claimed in claim 11, wherein the embedding step comprises the sub-step of randomly changing the time durations for which each watermark signal is applied and randomly changing the time durations to which the watermark signal is not applied.

13. A method as claimed in claim 1, wherein in a watermark embedding step each watermark is randomly multiplexed in at least one of the time-domain, the frequency-domain and the spatial-domain.

14. A method as claimed in claim 1, in which a watermark embedding step comprises the sub-step of generating a random function, the random function being used to control the random embedding of said watermark.

15. A method of detecting tampering with a watermark in an information signal, comprising the steps of:
receiving an information signal that may potentially be tampered with and which is potentially watermarked with at least one watermark randomly embedded in the original information signal;
analysing said signal so as to detect said watermark;
comparing the detected watermark with the expected watermark; and
if said detected watermark comprises an approximate negative version of the expected watermark then determining that tampering has occurred.

16. A method as claimed in claim 1, wherein the detected watermark carries a payload which is specific to a user or group of users, and tampering with the watermark is indicative of tampering by the user or group of users.

17. A method according to claim 1, wherein if tampering is found, then access to information content of the signal is denied.

18. An apparatus arranged to detect a watermark in an information signal, the apparatus comprising an estimator (420) for estimating the presence of a watermark in a received multimedia system, and a comparison module (440, 460) for comparing the estimated watermark with an expected watermark and deciding that tampering has taken place if the comparison module (440, 460) shows a sufficiently negative correlation between the estimated and expected watermarks.

19. The apparatus of claim 18, wherein the comparison module comprises a correlator (440) for correlating the estimated watermark and the expected watermark and a threshold comparator (460) for comparing the level of correlation output to a predetermined threshold.

20. An apparatus arranged to detect tampering with a watermark in an information signal comprising:
receiving means (300) arranged to receive a signal that may potentially be watermarked by at least one watermark randomly embedded in the original information signal;
first analysing means (310, 320) arranged to analyse said signal so as to detect said watermark; and
second analysing means (338) arranged to analyse said watermark so as to detect whether said watermark is a close match to an expected watermark, wherein said second analysing means is arranged to detect both positive correlation and negative correlation peaks between the received and expected watermarks, a sufficiently high positive correlation peak indicating correct receipt of a watermark and a sufficiently high negative correlation peak indicating that the information signal has been tampered with.

21. A computer program arranged to perform at least one of the methods of claim 1.

22. A record carrier comprising a computer program as claimed in claim 21.

23. A method of making available for downloading a computer program as claimed in claim 21.
